(19) United States
(12) Patent Application Publication
(10) Pub. No.: US 2016/0050936 A1
(43) Pub. Date: Feb. 25, 2016

(54) Methods and Compositions using Calcium Hydroxide to Provide a Prolonged Biocidal Effect

(71) Applicant: Donald Mark Meade, Barrie (CA)

(72) Inventor: Donald Mark Meade, Barrie (CA)

(21) Appl. No.: 14/464,516

(22) Filed: Aug. 20, 2014

(51) Int. Cl. A01N 59/06; F24F 3/16; C09D 5/14

(52) U.S. Cl. CPC A01N 59/06; C09D 5/14; F24F 3/1603; F24F 2003/1675

(57) ABSTRACT

A composition that can be used as an additive to paints, adhesives and resins to provide a prolonged effectiveness to kill microorganisms exposed to the coating is disclosed. The biocidal coating is comprised of a calcium hydroxide particulate that is within the matrix forming material (e.g. paint, adhesive, resin, etc.). The calcium hydroxide is hygroscopic and attracts waters at a surface of the biocidal coating to limit conversion of the calcium hydroxide particulate at the surface to calcium carbonate in order to maintain a high alkalinity of the biocidal coating. The calcium hydroxide particulate is produced through calcination of crushed limestone, hydration, and then grinding and classification to a particle size less than 25 microns. The calcium hydroxide particulate is then mixed with water in a desired ratio prior to adding to the matrix forming material. The mixture is then applied shortly after mixing.

### FIELD

The present disclosure relates generally to the use of calcium hydroxide as a biocide. More particularly, the disclosure relates to methods and compositions using calcium hydroxide that limits the conversion of calcium hydroxide to calcium carbonate when exposed to the ambient atmosphere to provide a prolonged biocidal effect.

### BACKGROUND

The U.S. Center for Disease Control and Prevention (CDC), the Institute of Medicine of the U.S. National Academy of Sciences, the World Health Organization, and Health Canada have all concluded that living or working in a building with mold damage results in an increased risk of respiratory disease.

The term “mold” is a colloquial term for a group of filamentous fungi that are common on food or wet materials. Outdoors, molds live in the soil, on plants, and on dead or decaying matter. There are thousands of species of mold and they can be any color. Different mold species are adapted to different moisture conditions ranging from very wet to just damp. Indoors, mold needs moisture to grow; it becomes a problem only where there is water damage, elevated and prolonged humidity, or dampness. Mold spores can be toxic as some of these fungi produce toxic metabolites (mycotoxins), and almost all molds that grow in the built environment can produce triple helical glucan, both of which are toxic to lung cells.

Biocides are disinfectant chemical used to destroy living microorganisms. The term generally refers to sterilizing cleaners, similar to hand sanitizers provided in doctors' offices, hospitals and gas stations. Biocides are marketed as a solution that immediately and quickly cleanses or disinfects an area that is being treated. The same idea applies to the use of biocides to cleanse or disinfect mold. These solutions are only partially effective as they kill 99.9% of microorganisms, however, the 0.1% remaining is plenty on a parts per million basis to regenerate mold in a short time period.

The American Industrial Hygiene Association (AIHA) concluded that these commonly used biocides do not effectively kill molds. For example, active fungal growth on a surface may produce a spore density of 1 million spores per square inch. Treating this site with a biocide that has an effectiveness of 99.999% would still leave an estimated 10 viable spores per square inch. As such, mold growth can recur if the underlying moisture problem is not resolved. This can allow mold to re-grow within 7-15 days based on the remaining viable spores. Biocides are also not effective against pathogens (found in toxic mold) which cause the single greatest harm to humans.

Biocides also quickly evaporate and are not capable of providing a lasting disinfectant effect. In some cases, biocides can promote mold growth as they can become acidic as tested over a period of 2 or 3 days. This acidity can provide a favorable environment for microorganisms that the biocide was intended to destroy.

International Patent Application No. WO2014/036659 provides proof of the disinfectant properties of calcium hydroxide and its use to destroy microbes (bacteria, fungus, mold, viruses and other micro-organisms). The patent application describes the use of a calcium hydroxide solution having a high pH that is used as a disinfectant formulation to kill microbes.

The problem with using calcium hydroxide as a disinfectant is that the active calcium hydroxide component converts back to calcium carbonate after some time due to exposure to carbon dioxide in the ambient air. Calcium carbonate does not have the alkalinity to be a disinfectant because of its almost neutral pH. Calcium hydroxide used in this manner will not have long lasting disinfectant properties due to surface conversion to calcium carbonate.

It has also been found that calcium carbonate can also create an environment that is favorable to mold. Building products that incorporate calcium carbonate as a filler can have the unwanted effect of drawing moisture and nutrients into the building product that creates an environment where mold and microorganisms can grow. If calcium hydroxide is to be used on or incorporated into building products, then the calcium hydroxide must be prevented from converting to calcium carbonate from carbon dioxide in the ambient air.

U.S. Pat. No. 7,883,681 granted to the inventor of the present application describes enclosing the calcium hydroxide particle in a calcium carbonate ring. It was believed that the protection of the calcium carbonate ring allowed the use of the otherwise reactive calcium hydroxide to be used within a resin matrix. However, it has been found that this advance carbonation provided by the calcium carbonate ring limits the effectiveness of calcium hydroxide as a long lasting disinfectant agent. U.S. Pat. No. 6,310,129, of which the inventor of the present application is a co-inventor, describes that the greater the extent of surface carbonation, the lower is the available particle surface area with accessible hydroxyl groups. Preventing access to the hydroxyl groups of the calcium hydroxide through surface carbonation prevents unwanted chemical reactions but at the same time prevents the use of the carbonated calcium hydroxide as an effective disinfectant agent.

Other approaches to the use of calcium hydroxide include the coatings that include a binder that prevents the passage of carbon dioxide into the coating. These binders, while limiting carbonation, typically also provide a barrier that prevents effective contact with calcium hydroxide.

Calcium hydroxide has also been used in the polymer used to make plastic bags for the food packaging industry. This allows the calcium hydroxide to scavenge at the surface of the packaging where the additive is present. Another example of the use of calcium hydroxide is provided by U.S. Pat. No. 6,451,423 that utilizes calcium hydroxide as a carbon dioxide scavenging element. Allowing calcium hydroxide to scavenge carbon dioxide results in quickly eliminating the biocidal properties of the calcium hydroxide.

### SUMMARY

According to a first aspect, a biocidal coating is provided comprising a calcium hydroxide particulate produced through calcination, hydration, grinding and classifying processes and a matrix forming material, wherein the calcium hydroxide is hygroscopic and attracts waters at a surface of the biocidal coating to limit conversion of the calcium hydroxide particulate at the surface to calcium carbonate to maintain a high alkalinity of the biocidal coating. In some aspects the matrix forming material is any one of a paint, an adhesive, a resin, a cementious material, foam, inks, rubber, and silicone. The biocidal coating can have a high alkalinity between 8.5 pH and 12.5 pH. The biocidal coating can also provide improved flame retardancy through a hard charcoal effect of calcium hydroxide during fire conditions. The biocidal coating can also provide alkalinity and hygroscopicity to damage insect exoskeletons to act as an insecticide. The biocidal coating can also be applied to food packaging to limit food spoilage.

In another aspect, a biocidal HVAC filter is provided comprising a permeable filter portion, the permeable filter portion treated with a biocidal coating comprising a calcium hydroxide particulate produced through a calcination and hydration process and an adhesive, wherein the calcium hydroxide is hygroscopic and attracts waters at a surface of the biocidal coating to limit conversion of the calcium hydroxide particulate at the surface to calcium carbonate to maintain a high alkalinity of the biocidal coating.

In yet another aspect, a method is provided for providing a biocidal coating, the method comprises calcining crushed lime at a high temperature to produce calcium oxide; hydrating the calcium oxide to produce calcium hydroxide; grinding and classifying the calcium hydroxide into a calcium carbonate particulate having a particle size less than 25 microns; mixing the calcium hydroxide with water in a ratio between 5% to 50% by volume to produce an admix; mixing the admix with a matrix forming material in a ratio between 5% to 50% by volume; and applying the mixture of the admix and matrix forming material shortly after mixing to an object surface to provide the biocidal coating, wherein the calcium hydroxide within the biocidal coating is hygroscopic and attracts waters at a surface of the biocidal coating to limit conversion of the calcium hydroxide particulate at the surface to calcium carbonate to maintain a high alkalinity of the biocidal coating.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a diagram illustrating a calcium hydroxide within a paint/adhesive/resin matrix showing the calcium hydroxide surrounded by water molecules to maintain the reactivity of the hydroxyl group of the calcium hydroxide and limit access of carbon dioxide to the calcium hydroxide.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementations of various embodiments described herein.

The term “microorganism” is used herein to refer to microscopic single cell or multicellular organisms, including bacteria, fungus, mold, and also to include viruses. The term “calcium hydroxide” is used herein to refer to a particulate formed by a calcine and hydration process as well as molecular calcium hydroxide (Ca(OH)2). It will be clear from the context which, or both, meaning is intended. The calcium hydroxide particulate is a colorless crystal or white powder that is produced from crushed lime (calcium carbonate (CaCO3)).

In the calcine process, the crushed lime is heated to about 1800 F which drives off the carbon dioxide from the lime to produce calcium oxide (CaO). The crushed lime can be calcined using an oven that promotes agitation of the lime to ensure an even heating and reaction of the lime. The calcine process breaks the calcium oxide into particles that are approximately 1 micron.

In the hydration process, the calcium oxide is then reacted with water to produce the calcium hydroxide. The hydration process can be controlled to maintain a preferred moisture content, preferably 0.10 percent water. The water can be sprayed onto the calcium oxide material at a rate of about 0.5 pounds of water per pound of material. The hydrating process can also be facilitated by agitating the material during hydration, to keep the material well dispersed and facilitate the reaction, including the fracturing of the material into small particles. Moreover, air can be flowed over the fractured calcium hydroxide particles. The air can be provided, for example, through one end of the hydration chamber, over the fractured calcium hydroxide particles a short time before the end of the reaction, a short time following the end of the reaction, or, preferably, at the end of the reaction. The air can also be provided into the hydrator under pressure.

The hydration process causes the particles to agglomerate which are then jet milled to mechanically separate the clumps. Forcing air over the fractured particles may inhibit the tendency of the 1 micron particles to agglomerate into larger clusters after the initial fracturing occurs. The hydration process can result the particles quickly agglomerating in the presence of moisture into clusters averaging about 5 to 7 microns, with a top size of about 100 microns. The particles can then be subjected to a jet mill grinding process to separate and classify the particulate size. The classified particulate can then be subjected to the grinding and classification process again for further selection of the desired calcium hydroxide particle size.

It is preferable that the calcium hydroxide particles have limited exposure to carbon dioxide. Exposure to carbon dioxide can cause surface carbonation on the calcium hydroxide particles, and thus, potentially limit their reactivity and effectiveness to destroy microorganisms. The hydration chamber and the remaining stages of milling, grinding, and processing can include an environment with limited carbon dioxide or reduced atmospheric pressure in order to limit carbonation of the calcium hydroxide particles. This is a diversion from the known approaches that typically allow for some surface carbonation of the calcium hydroxide particle which limits the particles reactivity.

The calcium hydroxide particles can be classified and to separate different sized particles and ground again until the desired particle size is achieved. In the embodiments described herein calcium hydroxide particles are selected having particle size of roughly less than 25 microns. The resultant calcium hydroxide particulate has a high alkalinity (up to 12.5 pH) and high hygroscopicity. The calcium hydroxide particulate is preferably stored in a dry and evacuated container to limit exposure to moisture and carbon dioxide.

One such calcium hydroxide product that can be used in the embodiments described herein is Rx100™ special Hydra DM Oxide brand made by from Rx100 Additives in Barrie, Ontario Canada.

The problem with calcium hydroxide is that it can convert over time to calcium carbonate when exposed to carbon dioxide in the ambient atmosphere. The converted calcium carbonate has a pH of approximately 7.5 and does not provide the alkalinity that destroys microorganisms and repels insects by burning the exoskeleton. If calcium hydroxide by itself is used as an additive in paint and adhesives, the surface of the coating exposed to the atmosphere will convert to calcium carbonate and thus, eliminating the biocidal properties of the coating. As described in the background section, other approaches at preserving the microorganism destroying properties of the coatings have been attempted with limited success.

In the embodiments described herein the microorganism destroying property is preserved by limiting the conversion of the calcium hydroxide to calcium carbonate. This is accomplished by taking advantage of the hygroscopic property of the calcium hydroxide to surround itself with water molecules to limit exposure to carbon dioxide. Moisture is desired by the water starved calcium hydroxide caused by the calcining process. The calcium hydroxide will scavenge water in place of carbon dioxide gas in the atmosphere. When used in a paint, adhesives and resins, these materials provide a matrix to lock in the calcium hydroxide particles and will draw moisture at the outer surface to block carbon dioxide uptake. This discovery that the moisture starved calcium hydroxide caused by the calcining process is able to draw moisture at the surface of a coating layer to block carbon dioxide uptake is counterintuitive to previous approaches that sought to block environmental access to the calcium hydroxide by carbonation or a binder.

Preventing carbon dioxide from accessing the calcium hydroxide particles in the matrix allows the matrix material to maintain a high enough pH to destroy microorganisms for an extended period of time. Therefore, if the calcium hydroxide particulate is added to the matrix material where it can stabilize with a new minimum water absorption rate, then the calcium hydroxide will maintain its alkalinity within the surrounding matrix and will not draw carbon dioxide but rather the moisture from the ambient atmosphere. Preventing carbonation of the calcium hydroxide preserves it reactivity, alkalinity, and microorganism destroying capability for a prolonged period of time (e.g. several years, and in some cases, forensic testing has indicated an ability to last over a century).

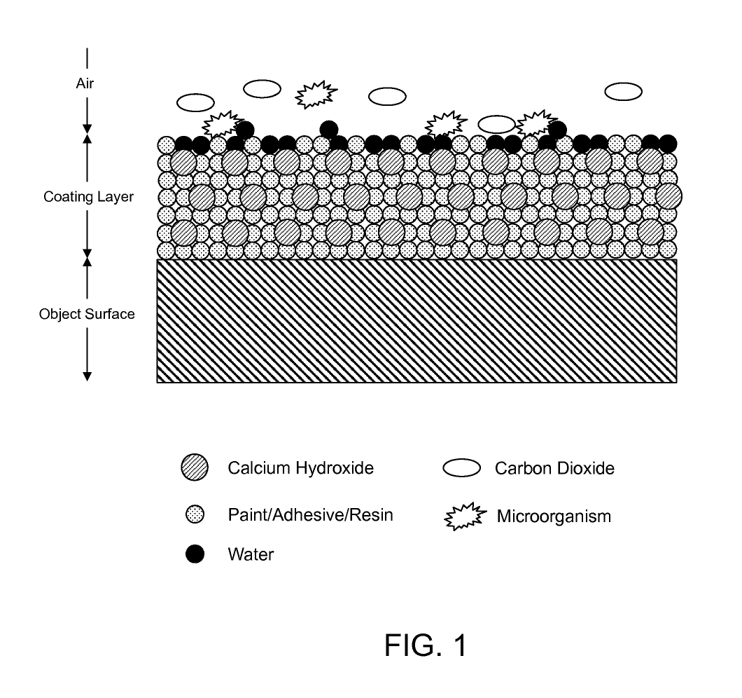

Referring now to FIG. 1, shown is a diagram illustrating a calcium hydroxide within a matrix forming material (e.g. paint, adhesive or resin) showing the calcium hydroxide at the surface of the matrix material surrounded by water molecules to maintain the reactivity of the hydroxyl group of the calcium hydroxide and limit access of carbon dioxide to the calcium hydroxide. The coating layer forms a matrix that encloses the calcium hydroxide and attracts water to the surface of the coating layer. The coating layer can be applied to an object surface to prevent the growth of microorganisms on the object surface. The coating layer is shown in FIG. 1 as being a paint, adhesive or resin but other substances that can be used can include, but are not limited to, cementious products like stucco and plaster, rubber, foam, and silicone caulk

The water molecules surround, or at least partially surround, the calcium hydroxide molecules at the surface of the matrix that maintains the hydroxyl ions of the calcium hydroxide in an ionized, highly alkaline state so that it will destroy microorganisms. The water also prevents conversion of the calcium hydroxide to calcium carbonate and allows the coating layer to maintain high pH over time that is effective for destroying microorganisms. The pH can be maintained between 8.5 and 12.5 for a prolonged period of time. The coating layer will destroy microorganisms that are drawn to the coating from the air as well as microorganisms that may be living on the object surface prior to application of the coating layer. Uptake of carbon dioxide in the air is limited by the water molecules and the paint matrix from reacting with the calcium hydroxide.

Testing has indicated that with application of calcium hydroxide (e.g. lime milk which is decanted water from the presence of lime which settled to the bottom of the decant container) the alkalinity dropped to neutral after 37 hours. Similarly, other biocides on the market have also been tested to reveal a return to a neutral pH after 21 to 42 hours after application. The embodiment illustrated in FIG. 1 is able to prevent surface carbonation to maintain its alkalinity at a pH of 8.5 to 12 for a period of years to provide a prolonged biocidal coating.

In order to produce the matrix illustrated in FIG. 1, the calcium hydroxide particulate can be added to water in the desired quantity and then added to the matrix forming material (e.g. paint, adhesive, resin, etc.) prior to application. It is preferred to mix the calcium hydroxide with water to limit exposure of the calcium hydroxide to atmospheric carbon dioxide. The water is preferably deionized or distilled water to prevent any undesired reactions with the calcium hydroxide or the coating layer material. Preferably, the calcium hydroxide can be used in a ratio of 5% to 50% to water by volume. In matrix material applications, the preferable ratio is 5% to 50% to the matrix material by volume. The calcium hydroxid particulate can also be used as a base cleaner or pre-prime coat using 5% to 50% ratio with water. Other applications can include the use of calcium hydroxide with a top coat using a 1% to 2% ratio in the top coat with water shaken into top coat material (e.g. paint or adhesive) just prior to application to maintain the high pH level without the pH going into the liquid which can then be subject to evaporation.

It is also preferred to apply the coating layer material to the object surface shortly after adding the calcium hydroxide to limit the reactivity of the calcium hydroxide with the coating layer material. In other embodiments, the calcium hydroxide and coating layer material can be sealed at the surface with a calcium hydroxide top coat to allow for the high pH while blocking carbon dioxide.

In one embodiment, the calcium hydroxide particulate described herein can be added to paints to provide a biocidal paint that will maintain its biocidal property for a prolonged period of time. These paints can include latex, oil or other solvent based paints. Calcium hydroxide particulate can be mixed with water and then added to the paint shortly before application of the paint.

The calcium hydroxide is preferably only added at the time the paint is mixed and used. This is used to control the loss of pH into liquids which evaporate. Depending on the quantity of calcium hydroxide used, the paint can provide a high pH between 8.5 and 12.5, which is sufficient to destroy microorganisms and insects.

In other embodiments, the calcium hydroxide particulate described herein can be added to adhesives and resins to provide biocidal properties that will last for a prolonged period of time.

The calcium hydroxide additive can also improve fire retardancy of the material. The calcium hydroxide particulate has a high melting point and exhibits a “hard char” effect after burning. Consequently, materials containing a sufficient level of calcium hydroxide will not simply burn and decompose but will result in a hard char that can protect other building materials. The calcium hydroxide will limit oxygen in a fire condition suppressing the flame to the hard charcoal effect to allow for increase time to exit structures made from timber framing.

Other embodiments can use an adhesive with the calcium hydroxide to provide a product that repels insects. The alkalinity and hygroscopicity of the calcium hydroxide will damage most insect's exoskeletons, thus killing the insect. The adhesive will maintain the insects in contact with calcium hydroxide to increase the efficiency of the insecticide as well as trap the dead insects in place for later examination. The adhesive used for insecticide applications can include that developed by Vapona and used in their pest strips.

Insecticide applications can be useful for bed bug control in buildings (such as hotels) where it is difficult or costly to treat the entire building at one time due to occupancy. The calcium hydroxide insecticide can be used when treating a room to prevent bed bugs from moving to an adjacent room. The insecticide can be atomized (sprayed) to surround the perimeter of a room, such as behind baseboards and behind wall receptacles.

Other embodiments can include use of the calcium hydroxide particulate with an adhesive incorporated into an air filter used vehicle, home, commercial, or industrial heating, ventilation and air conditioning (HVAC) systems. The permeable portion of the filter can be treated with the adhesive to trap and destroy airborne microorganisms.

Another embodiment can include using the calcium hydroxide admix combined with ink, solvent or latex based paints that are applied to food packaging, such as bags or containers. The calcium hydroxide can act as a moisture scavenger which will destroy microorganisms that may be present in the air within the packaging environment. This can prolong freshness by preventing the contents of the packaging from spoilage. The results of using such embodiments is that freshness can be maintained for as long as one to four weeks past current food packaging.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A biocidal coating comprising: a calcium hydroxide particulate produced through calcination, hydration, grinding and classifying processes; and a matrix forming material, wherein the calcium hydroxide is hygroscopic and attracts waters at a surface of the biocidal coating to limit conversion of the calcium hydroxide particulate at the surface to calcium carbonate to maintain a high alkalinity of the biocidal coating.

2. The biocidal coating of claim 1, wherein the matrix forming material is any one of a paint, an adhesive, a resin, a cementious material, foam, inks, rubber, and silicone.

3. The biocidal coating of claim 2, wherein the high alkalinity is a pH between 8.5 and 12.5.

4. The biocidal coating of claim 1, wherein the biocidal coating provides improved flame retardancy through a hard charcoal effect of calcium hydroxide during fire conditions.

5. The biocidal coating of claim 1, wherein the biocidal coating provides alkalinity and hygroscopicity to damage insect exoskeletons to provide an insecticide.

6. The biocidal coating of claim 1, wherein the biocidal coating is applied to food packaging to limit food spoilage.

7. A biocidal HVAC filter comprising a permeable filter portion, the permeable filter portion treated with a biocidal coating comprising a calcium hydroxide particulate produced through a calcination and hydration process and an adhesive, wherein the calcium hydroxide is hygroscopic and attracts waters at a surface of the biocidal coating to limit conversion of the calcium hydroxide particulate at the surface to calcium carbonate to maintain a high alkalinity of the biocidal coating.

8. A method of providing a biocidal coating, the method comprising:
calcining crushed lime at a high temperature to produce calcium oxide;
hydrating the calcium oxide to produce calcium hydroxide;
grinding and classifying the calcium hydroxide into a calcium carbonate particulate having a particle size less than 25 microns;
mixing the calcium hydroxide with water in a ratio between 5% to 50% by volume to produce an admix;
mixing the admix with a matrix forming material in a ratio between 5% to 50% by volume; and
applying the mixture of the admix and matrix forming material shortly after mixing to an object surface to provide the biocidal coating, wherein the calcium hydroxide within the biocidal coating is hygroscopic and attracts waters at a surface of the biocidal coating to limit conversion of the calcium hydroxide particulate at the surface to calcium carbonate to maintain a high alkalinity of the biocidal coating.
